(19) United States
(12) Patent Application Publication
(10) Pub. No.: US 2026/0200446 A1
(43) Pub. Date: Jul. 16, 2026

(54) BRAKING CONTROL METHOD AND APPARATUS FOR VEHICLE STARTING, STORAGE MEDIUM AND VEHICLE

(71) Applicant: NEXTEER AUTOMOTIVE (SUZHOU) CO., LTD., Jiangsu (CN)

(72) Inventors: Minqiang LI, Suzhou (CN); Meiping HUANG, Suzhou (CN); Zhiyou ZHANG, Suzhou (CN)

(21) Appl. No.: 19/374,099

(22) Filed: Oct. 30, 2025

(30) Foreign Application Priority Data
Nov. 11, 2024 (CN) 202411603018.0

(51) Int. Cl. B60T 8/172; B60T 8/171

(52) U.S. Cl. CPC B60T 8/172; B60T 8/171; B60T 2201/06; B60T 2220/06; B60T 2250/00

(57) ABSTRACT

Disclosed are a braking control method and apparatus for vehicle starting, a storage medium and a vehicle. The braking control method for vehicle starting includes: acquiring a real-time accelerator pedal opening or pedal position of a vehicle when the vehicle is in a parked state, and determining whether the real-time accelerator pedal opening or pedal position satisfies a parking release condition; sending an original parking torque of an electrical park brake system of the vehicle to an electromechanical brake system if the parking release condition is satisfied, and generating, by the electromechanical brake system according to the original parking torque, a clamping torque having a same magnitude as the original parking torque; and obtaining a real-time driving torque according to the real-time accelerator pedal opening or pedal position, and controlling the clamping torque to decrease with an increase in the real-time driving torque.

### CROSS REFERENCE TO RELATED APPLICATIONS

This U.S. utility patent application claims priority to and the benefit of CN application No. 202411603018.0, filed Nov. 11, 2024, the contents of which is incorporated herein by reference in its entirety.

### TECHNICAL FIELD

Embodiments of the present invention relate to the technical field of automotive braking, and in particular, to a braking control method and apparatus for vehicle starting, a storage medium, and a vehicle.

### BACKGROUND ART

An electrical park brake (EPB) system is increasingly applied to middle-end and high-end vehicle types in recent years, which is convenient to relieve a driver's operation and ensure vehicle parking safety.

In the prior art, the control process of automatically releasing the parking caliper of the EPB is that only when the accelerator pedal of the vehicle is pressed down and the driving force generated by the accelerator pedal is greater than the sum of all the rollback torques, the parking caliper of the EPB is automatically released to cancel the parking torque. Therefore, when the vehicle needs to be switched from a parked state to a driving state, the driver may operate the accelerator pedal to control the parking torque of the EPB to automatically release, so as to realize the vehicle starting operation. However, in the foregoing vehicle starting process, the process of automatically releasing the parking caliper of the EPB and canceling the parking torque is delayed, and if the driver operates the accelerator pedal too much or too fast, the jerking or dragging of the whole vehicle will be caused, which affects the driving comfort of the vehicle.

### SUMMARY OF THE INVENTION

The present invention provides a braking control method and apparatus for vehicle starting, a storage medium and a vehicle, so as to reduce the jerking and dragging problems during the vehicle starting process and improve the driving comfort of the vehicle.

In a first aspect, an embodiment of the present invention provides a braking control method for vehicle starting, comprising: acquiring a real-time accelerator pedal opening or pedal position of a vehicle when the vehicle is in a parked state, and determining whether the real-time accelerator pedal opening or pedal position satisfies a parking release condition; sending an original parking torque of an electrical park brake system of the vehicle to an electromechanical brake system if the parking release condition is satisfied, and generating, by the electromechanical brake system according to the original parking torque, a clamping torque having a same magnitude as the original parking torque; and obtaining a real-time driving torque according to the real-time accelerator pedal opening or pedal position, and controlling the clamping torque to decrease with an increase in the real-time driving torque.

Further, the method further comprises: determining whether the release of the original parking torque is completed according to the clamping torque.

Further, the determining whether the release of the original parking torque is completed according to the clamping torque comprises: if the clamping torque is less than a preset threshold, determining that the release of the original parking torque is completed; or if the clamping torque is greater than or equal to the preset threshold, determining that the release of the original parking torque is not completed, and continuing to control, according to the real-time driving torque, the clamping torque generated by the electromechanical brake system to synchronously decrease until the clamping torque is less than the preset threshold.

Further, after the determining that the release of the original parking torque is completed, the method further comprises: controlling the vehicle to start according to the driving torque corresponding to the accelerator pedal opening or pedal position of the vehicle at this time.

Further, the controlling the clamping torque to decrease with an increase in the real-time driving torque comprises: causing the clamping torque generated by the electromechanical brake system to decrease with an increase in the real-time driving torque, the clamping torque and the real-time driving torque satisfying: V_{drive}+V_{clamp}=V_{original}, wherein V_{drive} is the real-time driving torque, V_{clamp} is the clamping torque, and V_{original} is the original parking torque.

Further, determining whether the real-time accelerator pedal opening or pedal position satisfies a parking release condition comprises: if the real-time accelerator pedal opening or pedal position is greater than a preset position, determining that the parking release condition is satisfied; or if the real-time accelerator pedal opening or pedal position is less than or equal to the preset position, determining that the parking release condition is not satisfied.

Further, the sending an original parking torque of an electrical park brake system of the vehicle to an electromechanical brake system if the parking release condition is satisfied, and generating, by the electromechanical brake system according to the original parking torque, a clamping torque having a same magnitude as the original parking torque comprises: sending the original parking torque of the electrical park brake system of the vehicle to the electromechanical brake system if the parking release condition is satisfied, causing the electromechanical brake system to generate the clamping torque having the same magnitude as the original parking torque, and controlling an electromagnetic brake in the electrical park brake system to release.

Further, a braking control apparatus for vehicle starting is configured to perform the braking control method for vehicle starting according to any of the embodiments of the present invention, and comprises: an acquisition module, configured to acquire a real-time accelerator pedal opening or pedal position of a vehicle when the vehicle is in a parked state, and determine whether the real-time accelerator pedal opening or pedal position satisfies a parking release condition; a torque switching module, configured to send an original parking torque of an electrical park brake system of the vehicle to an electromechanical brake system when the parking release condition is satisfied, such that the electromechanical brake system generates, according to the original parking torque, a clamping torque having a same magnitude as the original parking torque; and a torque release module, configured to obtain a real-time driving torque according to the real-time accelerator pedal opening or pedal position, and control the clamping torque to decrease with an increase in the real-time driving torque.

In a third aspect, an embodiment of the present invention further provides a storage medium including computer-executable instructions, configured to perform the braking control method for vehicle starting according to any of the embodiments of the present invention.

In a fourth aspect, an embodiment of the present invention further provides a vehicle comprising the braking control apparatus for vehicle starting according to any of the embodiments of the present invention.

The present invention provides a braking control method and apparatus for vehicle starting, a storage medium and a vehicle. A real-time accelerator pedal opening or pedal position of the vehicle is acquired when a vehicle is in a parked state, and whether the real-time accelerator pedal opening or pedal position satisfies a parking release condition is determined; an original parking torque of an electrical park brake system of the vehicle is sent to an electromechanical brake system if the parking release condition is satisfied, and a clamping torque having a same magnitude as the original parking torque is generated by the electromechanical brake system according to the original parking torque; and a real-time driving torque is obtained according to the real-time accelerator pedal opening or pedal position, and the clamping torque is controlled to decrease with an increase in the real-time driving torque. In this way, smooth switching between a driving force and a braking force of the vehicle during the vehicle starting process is completed, and the jerking and dragging problems during the vehicle starting process are reduced, thereby ensuring the stability of the vehicle starting process and improving the driving comfort of the vehicle.

### BRIEF DESCRIPTION OF THE DRAWINGS

FIG. 1 is a flowchart of a braking control method for vehicle starting according to an embodiment of the present invention.

FIG. 2 is a flowchart of another braking control method for vehicle starting according to an embodiment of the present invention.

FIG. 3 is a schematic diagram of a starting process of a vehicle in the prior art.

FIG. 4 is a schematic diagram of a braking control method for vehicle starting according to an embodiment of the present invention.

FIG. 5 is a flowchart of still another braking control method for vehicle starting according to an embodiment of the present invention.

FIG. 6 is a schematic structural diagram of a braking control apparatus for vehicle starting according to an embodiment of the present invention.

### DETAILED DESCRIPTION OF THE EMBODIMENTS

The present invention will be further described in detail below with reference to the drawings and embodiments. It should be understood that the specific embodiments described herein are merely used to explain the present invention, rather than to limit the present invention. In addition, it should be noted that, for ease of description, only some but not all of the structures related to the present invention are shown in the drawings.

An embodiment of the present invention provides a braking control method for vehicle starting, which is applicable to a vehicle starting process. When the vehicle is switched from a parked state to a driving state, the method is used to control release of an original parking torque of an electrical park brake system, so that the jerking and dragging problems during the vehicle starting process can be reduced. The method may be performed by a braking control apparatus for vehicle starting, and the braking control apparatus for vehicle starting may be implemented in a form of hardware and/or software. FIG. 1 is a flowchart of a braking control method for vehicle starting according to an embodiment of the present invention. As shown in FIG. 1, the braking control method for vehicle starting includes:

S110, a real-time accelerator pedal opening or pedal position of a vehicle is acquired when the vehicle is in a parked state, and whether the real-time accelerator pedal opening or pedal position satisfies a parking release condition is determined.

When the vehicle is in a parked state, the EPB controls the parking brake through an electronic circuit, and functions as a mechanical pull-up handbrake. The electronic handbrake may not be manually turned off when the vehicle starts, and may be automatically turned off when a driver steps on the accelerator to start. In this process, if release timing of an original parking torque of the EPB is not calibrated, the brake assist function for the vehicle starting may cause the jerking or dragging of the whole vehicle. In the embodiment of the present invention, by monitoring the real-time accelerator pedal opening or pedal position of the vehicle, when the real-time accelerator pedal opening or pedal position of the vehicle starts to change, it can be determined that the vehicle starts, and then the release process of the original parking torque of the EPB is controlled, thereby reducing the jerking and dragging problems during the vehicle starting process.

Specifically, when the vehicle is in the parked state, the accelerator pedal opening or pedal position of the vehicle is zero. By monitoring the real-time accelerator pedal opening or pedal position of the vehicle, it can be determined that the vehicle enters the starting state from the parked state when the real-time accelerator pedal opening or pedal position of the vehicle changes from zero, and by determining whether the real-time accelerator pedal opening or pedal position satisfies the parking release condition, release timing of the original parking torque of the EPB is controlled according to the real-time accelerator pedal opening or pedal position, thereby accurately controlling the release process of the original parking torque of the EPB, so as to reduce the jerking and dragging problems during the vehicle starting process.

S120, an original parking torque of an electrical park brake system of the vehicle is sent to an electromechanical brake system if the parking release condition is satisfied, and a clamping torque having a same magnitude as the original parking torque is generated by the electromechanical brake system according to the original parking torque.

The electromechanical brake (EMB) system mainly includes a motor, a reducer, a clamping device, a caliper, a controller, and the like, and achieves braking by driving a brake caliper or a brake pad with the motor. In the EMB system, the motor is a driving core of the entire system and is responsible for providing power, the reducer is used to convert high-speed rotation of the motor into low-speed and high-torque rotational motion to meet a requirement of the brake system, and the clamping device converts the rotational motion of the motor into linear motion of a friction plate, so that the friction plate is in contact with a brake disc to generate a friction force, thereby achieving braking. The original parking torque of the electrical park brake system is a torque generated by the EPB by controlling the parking brake through the electronic circuit when the vehicle is in the parked state.

Specifically, the original parking torque of the electrical park brake system of the vehicle is sent to the electromechanical brake system if the real-time accelerator pedal opening or pedal position satisfies the parking release condition, and at the same time, the clamping torque having a same magnitude as the original parking torque is generated by the electromechanical brake system according to the original parking torque, and after the electromechanical brake system controls its own brake motor to generate the clamping torque, the original parking torque of the electrical park brake system is released, so that the brake motor of the electromechanical brake system controls the vehicle to be stationary. By delivering the original parking torque of the EPB to the EMB, the clamping torque having a same magnitude as the original parking torque is generated by the brake motor of the EMB, so that vehicle parking can be achieved, and in the subsequent control process, the magnitude of the clamping torque can be finely regulated by the EMB, so as to reduce the jerking and dragging problems during the vehicle starting process.

S130, a real-time driving torque is obtained according to the real-time accelerator pedal opening or pedal position, and the clamping torque is controlled to decrease with an increase in the real-time driving torque.

A displacement sensor is disposed on an accelerator pedal (also referred to as an acceleration pedal) of a vehicle accelerator. When the driver steps on the accelerator pedal, the displacement sensor can monitor a change of an accelerator pedal opening or pedal position in real time, to obtain a real-time accelerator pedal opening or pedal position. A real-time driving torque corresponding to the vehicle may be calculated according to the real-time accelerator pedal opening or pedal position.

Specifically, after the clamping torque having a same magnitude as the original parking torque is generated by the electromechanical brake system according to the original parking torque, the clamping torque enables the vehicle to remain stationary, and the vehicle is still in the parked state. At this time, calculating the real-time driving torque of the vehicle according to the real-time accelerator pedal opening or pedal position, and controlling the clamping torque to decrease with an increase in the real-time driving torque in order to reduce the jerking and dragging problems during the vehicle starting process, are equivalent to gradually reducing the original parking torque of the vehicle until the vehicle starts, so that smooth switching between a driving force and a braking force of the vehicle during the vehicle starting process is realized, and the jerking and dragging problems during the vehicle starting process are reduced, thereby ensuring the stability of the vehicle starting process and improving the driving comfort of the vehicle.

An embodiment of the present invention provides a braking control method for vehicle starting. A real-time accelerator pedal opening or pedal position of the vehicle is acquired when a vehicle is in a parked state, and whether the real-time accelerator pedal opening or pedal position satisfies a parking release condition is determined; an original parking torque of an electrical park brake system of the vehicle is sent to an electromechanical brake system if the parking release condition is satisfied, and a clamping torque having a same magnitude as the original parking torque is generated by the electromechanical brake system according to the original parking torque; and a real-time driving torque is obtained according to the real-time accelerator pedal opening or pedal position, and the clamping torque is controlled to decrease with an increase in the real-time driving torque. In this way, smooth switching between a driving force and a braking force of the vehicle during the vehicle starting process is completed, and the jerking and dragging problems during the vehicle starting process are reduced, thereby ensuring the stability of the vehicle starting process and improving the driving comfort of the vehicle.

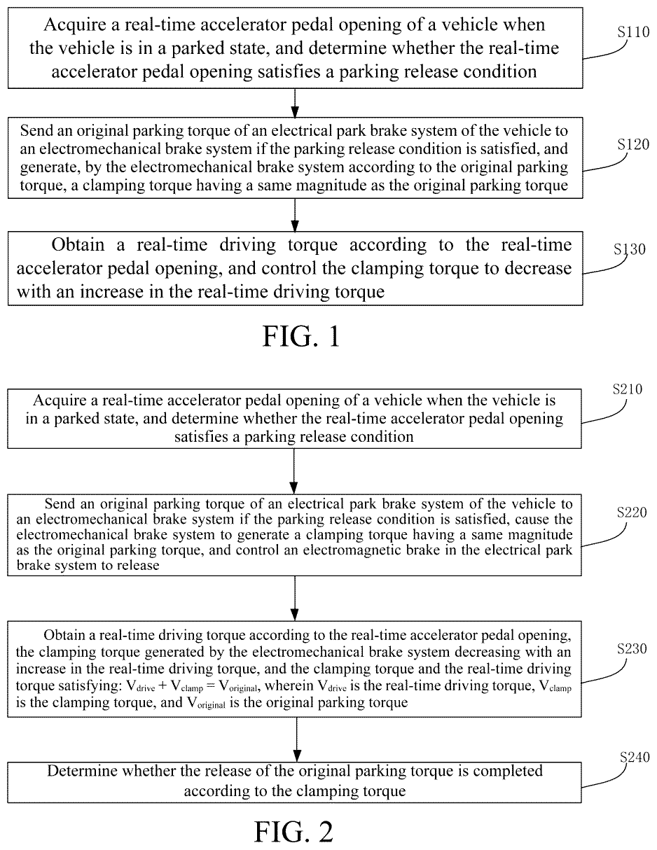

An embodiment of the present invention further provides another braking control method for vehicle starting, so as to further reduce the jerking and dragging problems during the vehicle starting process. FIG. 2 is a flowchart of the other braking control method for vehicle starting according to the embodiment of the present invention. As shown in FIG. 2, the braking control method for vehicle starting specifically includes:

S210, a real-time accelerator pedal opening or pedal position of a vehicle is acquired when the vehicle is in a parked state, and whether the real-time accelerator pedal opening or pedal position satisfies a parking release condition is determined.

Optionally, determining whether the real-time accelerator pedal opening or pedal position satisfies the parking release condition includes:
if the real-time accelerator pedal opening or pedal position is greater than a preset position, determining that the parking release condition is satisfied; or if the real-time accelerator pedal opening or pedal position is less than or equal to the preset position, determining that the parking release condition is not satisfied.

Specifically, when the vehicle is in the parked state, the real-time accelerator pedal opening or pedal position of the vehicle is acquired, and when the real-time accelerator pedal opening or pedal position is greater than the preset position, it is determined that the current vehicle satisfies the parking release condition, and the original parking torque of the EPB may be controlled to be released, where the parking release condition is that the real-time accelerator pedal opening or pedal position of the current vehicle is greater than the preset position. The preset position may be calibrated according to the basic performance of the vehicle, and the preset position is 3% by default.

If the real-time accelerator pedal opening or pedal position is less than or equal to the preset position, the parking release condition is not satisfied. The real-time accelerator pedal opening or pedal position of the vehicle continues to be acquired until the real-time accelerator pedal opening or pedal position is greater than the preset position, and the current vehicle satisfies the parking release condition, so as to ensure that when the accelerator pedal opening or pedal position is at the preset position, the release process of the original parking torque of the EPB is accurately controlled, thereby reducing the jerking and dragging problems during the vehicle starting process.

S220, an original parking torque of an electrical park brake system of the vehicle is sent to an electromechanical brake system if the parking release condition is satisfied, the electromechanical brake system is caused to generate a clamping torque having a same magnitude as the original parking torque, and an electromagnetic brake in the electrical park brake system is controlled to release.

Specifically, if the real-time accelerator pedal opening or pedal position is greater than the preset position, the original parking torque of the electrical park brake system of the vehicle is sent to the electromechanical brake system, and at the same time, the clamping torque having a same magnitude as the original parking torque is generated by the electromechanical brake system according to the original parking torque. After the electromechanical brake system controls its own brake motor to generate the clamping torque, the original parking torque of the electrical park brake system is released by controlling the electromagnetic brake in the electrical park brake system to release, so that the clamping torque generated by the brake motor of the electromechanical brake system controls the vehicle to be stationary. In the subsequent control process, the magnitude of the clamping torque may be finely regulated by the electromechanical brake system, so as to reduce the jerking and dragging problems during the vehicle starting process.

S230, a real-time driving torque is obtained according to the real-time accelerator pedal opening or pedal position, the clamping torque generated by the electromechanical brake system is controlled to decrease with an increase in the real-time driving torque, and the clamping torque and the real-time driving torque satisfy: V_{drive}+V_{clamp}=V_{original}; wherein V_{drive} is the real-time driving torque, V_{clamp} is the clamping torque, and V_{original} is the original parking torque.

Specifically, the real-time driving torque of the vehicle may be calculated according to the real-time accelerator pedal opening or pedal position. For example, real-time driving forces corresponding to different accelerator pedal openings or pedal positions of the vehicle may be calibrated in advance, to determine the real-time driving torque of the vehicle according to the real-time accelerator pedal opening or pedal position. Controlling the clamping torque to synchronously decrease with an increase in the real-time driving torque and ensuring that V_{drive}+V_{clamp}=V_{original} in this process, so that the vehicle can be maintained in the parked state to prevent vehicle rollback and eliminate vehicle lurching or jerking, are equivalent to gradually reducing the original parking torque of the vehicle until the vehicle starts, so that the jerking and dragging problems during the vehicle starting process are reduced, thereby ensuring the stability of the vehicle starting process and improving the driving comfort of the vehicle.

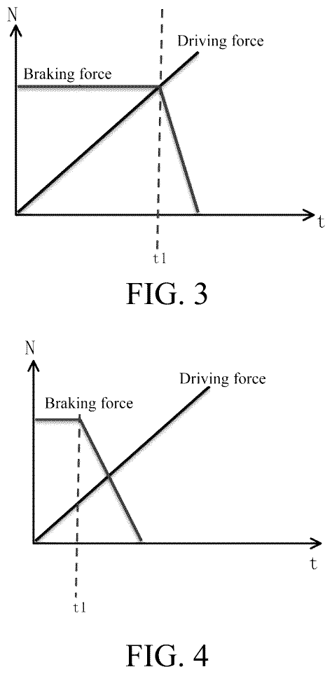

FIG. 3 is a schematic diagram of a starting process of a vehicle in the prior art, and FIG. 4 is a schematic diagram of a braking control method for vehicle starting according to an embodiment of the present invention. As shown in FIG. 3 and FIG. 4, there is switching between a braking force and a driving force during the vehicle starting process, and the release points of the original parking torque during the vehicle starting process in the prior art and in the embodiment of the present invention are different, wherein the braking force is the original parking torque and the clamping torque, the driving force of the vehicle is a driving torque generated by stepping on the accelerator pedal, and the moment t1 is the release point of the original parking torque of the EPB. As shown in FIG. 3, in the process of automatically releasing the original parking torque of the EPB in the prior art, when the driving force is greater than the sum of all the rollback torques, it is usually used as the release timing of the original parking torque. The release timing of the original parking torque is relatively late, which may cause problems such as long vehicle starting time, dragging in starting, uneven starting, and difficulty in calibrating the automatic release timing of the original torque, due to different rollback torques when the vehicle is on different roads. Compared with the process of automatically releasing the original parking torque of the EPB in the prior art, according to the braking control method for vehicle starting in the embodiment of the present invention, the release timing of the original parking torque can be calibrated in advance through the preset accelerator pedal opening or pedal position. That is, at the moment t1, the original parking torque of the EPB is released, the original parking torque of the EPB of the vehicle is sent to the EMB, and the clamping torque having a same magnitude as the original parking torque is generated by the EMB according to the original parking torque. Then, the original parking torque is converted into the clamping torque since the moment t1, and the clamping torque starts to gradually decrease with an increase in the driving torque, so that smooth switching between a driving force and a braking force of the vehicle during the vehicle starting process is realized, and the jerking and dragging problems during the vehicle starting process are reduced, resulting in fast vehicle starting time, small dragging feeling in vehicle starting, even starting, and easy in calibrating the automatic release timing of the original torque, thereby ensuring the stability of the vehicle starting process and improving the driving comfort of the vehicle.

S240, whether the release of the original parking torque is completed is determined according to the clamping torque.

Optionally, determining whether the release of the original parking torque is completed according to the clamping torque includes: if the clamping torque is less than a preset threshold, determining that the release of the original parking torque is completed; or if the clamping torque is greater than or equal to the preset threshold, determining that the release of the original parking torque is not completed, and continuing to control, according to the real-time driving torque, the clamping torque generated by the electromechanical brake system to synchronously decrease until the clamping torque is less than the preset threshold.

Specifically, if the clamping torque is less than the preset threshold, it is determined that the release of the original parking torque is completed, and at this time, the driving torque of the vehicle enables the vehicle to start. According to the driving torque corresponding to the accelerator pedal opening or pedal position of the vehicle at this time, the vehicle can be controlled to start smoothly, and the clamping torque can be correspondingly released. If the clamping torque is greater than or equal to the preset threshold, it is determined that the release of the original parking torque is not completed, and the clamping torque generated by the electromechanical brake system continues to be controlled according to the real-time driving torque to synchronously decrease until the clamping torque is less than the preset threshold. The preset threshold may be determined by calibrating the whole vehicle, and by calibrating a suitable preset threshold, excessive jerking and discomfort of the vehicle can be prevented, and the driving comfort of the vehicle is improved.

Further, after determining that the release of the original parking torque is completed, the method further includes: controlling the vehicle to start according to the driving torque corresponding to the accelerator pedal opening or pedal position of the vehicle at this time.

Specifically, after it is determined that the release of the original parking torque is completed if the clamping torque is less than the preset threshold, the vehicle is controlled to start according to the driving torque corresponding to the accelerator pedal opening or pedal position of the vehicle at this time, ensuring that when the vehicle is driven to start by the driving torque corresponding to the accelerator pedal opening or pedal position of the vehicle at this time, there is no excessive jerking and discomfort, and the driving comfort of the vehicle is improved.

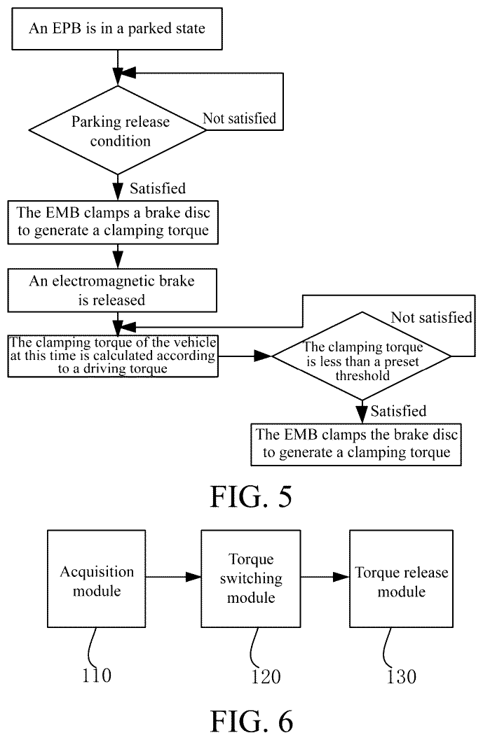

In addition, FIG. 5 is a flowchart of still another braking control method for vehicle starting according to an embodiment of the present invention. As shown in FIG. 5, when an EPB of a vehicle is in a parked state, it is detected whether a parking release condition of an original parking torque is satisfied, that is, whether a real-time accelerator pedal opening or pedal position satisfies the parking release condition is determined according to the real-time accelerator pedal opening or pedal position of the vehicle; when the parking release condition is satisfied, the original parking torque of an electrical park brake system of the vehicle is sent to an EMB, a clamping torque having a same magnitude as the original parking torque is generated by the EMB by clamping a brake disc, and an electromagnetic brake in the EPB is released; the clamping torque of the vehicle at this time is calculated according to the driving torque, that is, the clamping torque decreases with an increase in the real-time driving torque, and the clamping torque and the real-time driving torque satisfy: V_{drive}+V_{clamp}=V_{original}; if the clamping torque is less than a preset threshold, it is determined that the release of the original parking torque is completed; if the clamping torque is greater than or equal to the preset threshold, it is determined that the release of the original parking torque is not completed, and the clamping torque generated by the electromechanical brake system continues to be controlled according to the real-time driving torque to synchronously decrease until the clamping torque is less than the preset threshold, and it is determined that the release of the original parking torque is completed.

According to the braking control method for vehicle starting in the embodiment of the present invention, by controlling the clamping torque to decrease with an increase in the real-time driving torque, the sum of the clamping torque and the real-time driving torque is equal to the original parking torque, so that smooth switching between a driving force and a braking force of the vehicle during the vehicle starting process is achieved, and the jerking and dragging problems during the vehicle starting process are reduced, thereby ensuring the stability of the vehicle starting process and improving the driving comfort of the vehicle.

An embodiment of the present invention further provides a braking control apparatus for vehicle starting, and FIG. 6 is a schematic structural diagram of the braking control apparatus for vehicle starting according to the embodiment of the present invention, configured to perform the braking control method for vehicle starting in any of the embodiments of the present invention. As shown in FIG. 6, the braking control apparatus for vehicle starting includes: an acquisition module 110, configured to acquire a real-time accelerator pedal opening or pedal position of a vehicle when the vehicle is in a parked state, and determine whether the real-time accelerator pedal opening or pedal position satisfies a parking release condition; a torque switching module 120, configured to send an original parking torque of an electrical park brake system of the vehicle to an electromechanical brake system when the parking release condition is satisfied, such that the electromechanical brake system generates, according to the original parking torque, a clamping torque having a same magnitude as the original parking torque; and a torque release module 130, configured to obtain a real-time driving torque according to the real-time accelerator pedal opening or pedal position, and control the clamping torque to decrease with an increase in the real-time driving torque.

Specifically, the acquisition module 110 acquires the real-time accelerator pedal opening or pedal position of the vehicle by monitoring when the vehicle is in the parked state, and can determine that the vehicle enters the starting state from the parked state when the real-time accelerator pedal opening or pedal position of the vehicle changes from zero. The torque switching module 120 sends the original parking torque of the electrical park brake system of the vehicle to the electromechanical brake system when the real-time accelerator pedal opening or pedal position satisfies the parking release condition, and at the same time, controls the electromechanical brake system to generate, according to the original parking torque, the clamping torque having a same magnitude as the original parking torque, and after the electromechanical brake system controls its own brake motor to generate the clamping torque, releases the original parking torque in the electrical park brake system, so that the brake motor of the electromechanical brake system controls the vehicle to be stationary. The torque release module 130 calculates the real-time driving torque of the vehicle according to the real-time accelerator pedal opening or pedal position, and controls the clamping torque to decrease with an increase in the real-time driving torque in order to reduce the jerking and dragging problems during the vehicle starting process, which are equivalent to gradually reducing the original parking torque of the vehicle until the vehicle starts, so that smooth switching between a driving force and a braking force of the vehicle during the vehicle starting process is realized, and the jerking and dragging problems during the vehicle starting process are reduced, thereby ensuring the stability of the vehicle starting process and improving the driving comfort of the vehicle.

According to the braking control method for vehicle starting in the embodiment of the present invention, a real-time accelerator pedal opening or pedal position of the vehicle is acquired by the acquisition module when a vehicle is in a parked state, and whether the real-time accelerator pedal opening or pedal position satisfies a parking release condition is determined; an original parking torque of an electrical park brake system of the vehicle is sent by the torque switching module to an electromechanical brake system if the parking release condition is satisfied, and a clamping torque having a same magnitude as the original parking torque is generated by the electromechanical brake system according to the original parking torque; and a real-time driving torque is obtained by the torque release module according to the real-time accelerator pedal opening or pedal position, and the clamping torque is controlled to decrease with an increase in the real-time driving torque. In this way, smooth switching between a driving force and a braking force of the vehicle during the vehicle starting process is completed, and the jerking and dragging problems during the vehicle starting process are reduced, thereby ensuring the stability of the vehicle starting process and improving the driving comfort of the vehicle.

In addition, the braking control apparatus for vehicle starting in the embodiment of the present invention includes, but is not limited to, the foregoing modules, and may be adaptively provided with related functional modules according to the braking control method for vehicle starting in any of the embodiments of the present invention, to realize the functions and technical effects of the braking control method for vehicle starting in any of the embodiments of the present invention.

An embodiment of the present invention further provides a computer-readable storage medium storing a computer program thereon, wherein the program, when executed by a processor, implements the braking control method for vehicle starting according to the embodiment of the present invention, including: acquiring a real-time accelerator pedal opening or pedal position of a vehicle when the vehicle is in a parked state, and determining whether the real-time accelerator pedal opening or pedal position satisfies a parking release condition; sending an original parking torque of an electrical park brake system of the vehicle to an electromechanical brake system if the parking release condition is satisfied, and generating, by the electromechanical brake system according to the original parking torque, a clamping torque having a same magnitude as the original parking torque; and obtaining a real-time driving torque according to the real-time accelerator pedal opening or pedal position, and controlling the clamping torque to decrease with an increase in the real-time driving torque.

Of course, the computer program stored on the computer-readable storage medium according to the embodiment of the present invention is not limited to the above method operations, and may also perform related operations in the braking control method for vehicle starting according to any embodiment of the present invention.

The computer storage medium in the embodiment of the present invention may be any combination of one or more computer readable media. The computer-readable medium may be a computer-readable signal medium or a computer-readable storage medium. The computer-readable storage medium may be, for example, but not limited to, an electronic, magnetic, optical, electromagnetic, infrared, or semiconductor system, system, or device, or any combination of the above. More specific examples (non-exhaustive list) of computer-readable storage media include an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this document, the computer-readable storage medium may be any tangible medium containing or storing a program that may be used by or in combination with an instruction execution system, system, or device.

The program code contained on the computer-readable medium may be transmitted by any suitable medium, including but not limited to wireless, wireline, optical fiber cable, or the like, or any suitable combination of the above.

Computer program code for carrying out operations of the present invention may be written in one or more programming languages, including an object-oriented programming language such as Java, Smalltalk, C++ or the like and conventional procedural programming languages, such as “C” programming language or similar programming languages, or combinations thereof. The program code may be executed entirely on a user's computer, partly on a user's computer, as a stand-alone software package, partly on a user's computer and partly on a remote computer, or entirely on a remote computer or server. In the scenario involving a remote computer, the remote computer may be connected to a user's computer through any type of network, including a local area network (LAN) or a wide area network (WAN), or may be connected to an external computer (for example, through the Internet using an internet service provider).

An embodiment of the present invention further provides a vehicle including the braking control apparatus for vehicle starting in the above embodiment, thereby realizing the functions and technical effects of the braking control apparatus for vehicle starting in the above embodiment.

Of course, the vehicle in the embodiment of the present invention includes, but is not limited to, the braking control apparatus for vehicle starting in the above embodiment, and may also perform related operations in the braking control method for vehicle starting in any of the embodiments of the present invention, and can realize the same technical effects as in the braking control method for vehicle starting.

It should be noted that the above are only preferred embodiments of the present invention and the technical principles used. Those skilled in the art will appreciate that the present invention is not limited to the specific embodiments herein, and that various obvious changes, readjustments, and substitutions can be made by those skilled in the art without departing from the scope of protection of the present invention. Therefore, although the present invention has been described in detail through the above embodiments, the present invention is not limited to the above embodiments, and can also include more other equivalent embodiments without departing from the concept of the present invention, and the scope of the present invention is determined by the scope of the appended claims.

1. A braking control method for vehicle starting, the method comprising:
acquiring a real-time accelerator pedal position of a vehicle when the vehicle is in a parked state, and determining whether the real-time accelerator pedal position satisfies a parking release condition;
sending an original parking torque of an electrical park brake system of the vehicle to an electromechanical brake system if the parking release condition is satisfied, and generating, by the electromechanical brake system according to the original parking torque, a clamping torque having a same magnitude as the original parking torque; and
obtaining a real-time driving torque according to the real-time accelerator pedal position, and controlling the clamping torque to decrease with an increase in the real-time driving torque.

2. The braking control method for vehicle starting according to claim 1, further comprising: determining whether the release of the original parking torque is completed according to the clamping torque.

3. The braking control method for vehicle starting according to claim 2, wherein the determining whether the release of the original parking torque is completed according to the clamping torque comprises:
if the clamping torque is less than a preset threshold, determining that the release of the original parking torque is completed; or
if the clamping torque is greater than or equal to the preset threshold, determining that the release of the original parking torque is not completed, and continuing to control, according to the real-time driving torque, the clamping torque generated by the electromechanical brake system to synchronously decrease until the clamping torque is less than the preset threshold.

4. The braking control method for vehicle starting according to claim 3, wherein after the determining that the release of the original parking torque is completed, the method further comprises:
controlling the vehicle to start according to the driving torque corresponding to the accelerator pedal position of the vehicle at this time.

5. The braking control method for vehicle starting according to claim 1, wherein the controlling the clamping torque to decrease with an increase in the real-time driving torque comprises:
causing the clamping torque generated by the electromechanical brake system to decrease with an increase in the real-time driving torque, the clamping torque and the real-time driving torque satisfying:
$${V}_{drive} + {V}_{clamp} = {V}_{original} ;$$
wherein V_{drive} is the real-time driving torque, V_{clamp} is the clamping torque, and V_{original} is the original parking torque.

6. The braking control method for vehicle starting according to claim 1, wherein determining whether the real-time accelerator pedal position satisfies a parking release condition comprises:
if the real-time accelerator pedal position is greater than a preset position, determining that the parking release condition is satisfied; or
if the real-time accelerator pedal position is less than or equal to the preset position, determining that the parking release condition is not satisfied.

7. The braking control method for vehicle starting according to claim 1, wherein the sending an original parking torque of an electrical park brake system of the vehicle to an electromechanical brake system if the parking release condition is satisfied, and generating, by the electromechanical brake system according to the original parking torque, a clamping torque having a same magnitude as the original parking torque comprises:
sending the original parking torque of the electrical park brake system of the vehicle to the electromechanical brake system if the parking release condition is satisfied, causing the electromechanical brake system to generate the clamping torque having the same magnitude as the original parking torque, and controlling an electromagnetic brake in the electrical park brake system to release.

8. A braking control apparatus for vehicle starting, comprising:
an acquisition module, configured to acquire a real-time accelerator pedal position of a vehicle when the vehicle is in a parked state, and determine whether the real-time accelerator pedal position satisfies a parking release condition;
a torque switching module, configured to send an original parking torque of an electrical park brake system of the vehicle to an electromechanical brake system when the parking release condition is satisfied, such that the electromechanical brake system generates, according to the original parking torque, a clamping torque having a same magnitude as the original parking torque; and
a torque release module, configured to obtain a real-time driving torque according to the real-time accelerator pedal position, and control the clamping torque to decrease with an increase in the real-time driving torque.

9. A storage medium including computer-executable instructions, characterized in that the computer-executable instructions, when executed by a computer processor, are configured to perform the braking control method for vehicle starting according to claim 1.

10. A vehicle comprising the braking control apparatus for vehicle starting according to claim 8.
